(19) United States
(12) Patent Application Publication
(10) Pub. No.: US 2008/0299482 A1
(43) Pub. Date: Dec. 4, 2008

(54) METHOD OF MANUFACTURING AQUEOUS DISPERSION OF RESIN FINE PARTICLES, AQUEOUS DISPERSION OF RESIN FINE PARTICLES, METHOD OF MANUFACTURING TONER, AND TONER

(75) Inventors: Masayoshi Kato, Tokyo (JP); Takayuki Toyoda, Yokohama-shi (JP); Takeshi Miyazaki, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/179,074

(22) Filed: Jul. 24, 2008

Related U.S. Application Data
(63) Continuation of application No. PCT/JP2008/052689, filed on Feb. 19, 2008.

(30) Foreign Application Priority Data
Feb. 19, 2007 (JP) 2007-037656

(51) Int. Cl. G03G 9/13; C08L 67/00; C08L 33/08

(52) U.S. Cl. 430/113; 524/539; 524/600; 524/560

(57) ABSTRACT

A method of manufacturing an aqueous dispersion of resin fine particles, including: a mixing step of mixing an aqueous medium, a resin having an acid group, a basic substance, and a surfactant to obtain a mixture; an emulsification step of applying a shearing force to the mixture while heating at temperature 10.0° C. or more higher than a softening temperature (Tm) of the resin having the acid group to obtain an emulsified product; and a cooling step of obtaining an aqueous dispersion of resin fine particles by cooling the emulsified product, in which, in the cooling step, cooling is carried out at a cooling rate of 0.5° C./min or more to 10.0° C./min or less to a glass transition temperature (Tg) of the resin having the acid group or lower while a shearing force is applied.

### FIELD OF THE INVENTION

The present invention relates to a method of manufacturing an aqueous dispersion of resin fine particles used in the fields of, for example, printing materials such as toner and ink for electrophotography, paints, bonds, adhesives, textile processing, paper manufacture and paper processing, and engineering works, an aqueous dispersion of resin fine particles which can be obtained by the manufacturing method, a method of manufacturing electrophotographic toner using the aqueous dispersion of resin fine particles, and an electrophotographic toner which can be obtained by the method of manufacturing electrophotographic toner.

### BACKGROUND OF THE INVENTION

In a worldwide trend toward energy conservation in recent years, there are large social demands for how to supply commodities and a manufacturing method thereof with low energy and low environment load in the industrial field. On the other hand, demands for high-definition outputs of printing, copying, and the like by users at ordinary households, offices, and publish areas have increased on a daily basis owing to the rapid growth of the present digitizing technology. In order to reply the demand for high definition, for example, in the case of toner used for electrophotography, one of the technically important approaches is to increase the resolving power by reducing the particle diameter of the toner. At present, toner particles can be minimized to a volume-average particle diameter of 5 μm. However, from the viewpoint of production energy and cost effectiveness, a kneading/mixing method which has been conventionally used is hardly employed for producing toner with a volume-average particle diameter of 6 μm or less, on which a grain size distribution is sufficiently controlled. Therefore, at present, the method of manufacturing toner is shifting to the so-called chemical production method such as a suspension polymerization method, a dissolution suspension method, or an emulsion aggregation method each of which is employed in an aqueous medium. Of those manufacturing methods, the emulsion aggregation method attracts attention because of a possibility of controlling the shapes and dispersibility of particles in a purposeful way.

The electrophotographic toner which can be obtained by employing the above emulsion aggregation method is prepared by finely dispersing constituent materials for the toner such as resin, pigments, and wax separately in an aqueous medium and then mixing their respective aqueous dispersions to recombine them together. In this time, for obtaining electrophotographic toner with the above volume-average particle diameter of 6 μm or less, it is desirable to further disperse resin fine particles finely in an aqueous dispersion of the resin fine particles.

One of the methods for producing an aqueous dispersion of resin fine particles may be an emulsion polymerization method. The emulsion polymerization method is a method of generating an aqueous dispersion of resin fine particles by dispersing monomers in water or a poor solvent to form an O/W emulsion and carrying out radical polymerization of particles of the dispersed monomers. Therefore, the emulsion polymerization method has been a method of manufacturing an aqueous dispersion of resin fine particles which can be applied only to monomers which can be polymerized by radical polymerization (e.g., styrene monomers, acryl monomers, or vinyl monomers). Therefore, the types of the monomers have been limited in the aqueous dispersion of resin fine particles by the above emulsion polymerization method, so that the types of the resins to be obtained are limited.

Another method of obtaining an aqueous dispersion of resin fine particles may be a dispersion-granulating method. For example, a phase-transition emulsifying method is one of such dispersion-granulating methods. A specific example of the dispersion-granulating method, which has been known in the art, is one in which phase-transition emulsification is carried out such that an aqueous medium is added to a resin solution prepared by dissolving a polyester resin having a neutralization salt structure in a water-miscible organic solvent, and an organic solvent is then removed (see, for example, JP-B-61-58092 and JP-B-64-10547).

However, in the dispersion-granulating method, it is difficult to remove an organic solvent from the aqueous dispersion of resin fine particles completely. Even if the removal is possible, the production process becomes complicated to result in an increase in cost, and may also becomes lead to size variations of resin fine particles.

A method of manufacturing an aqueous dispersion of resin fine particles without using any organic solvent has been also known in the art. For example, a thermoplastic resin with self-emulsifiability is pressurized in an aqueous alkaline solution and then is emulsified by heating up to a temperature higher than the melting point of the resin to obtain the aqueous dispersion of resin fine particles (see, for example, JP-A-8-245769, JP-A-2001-305796, JP-A-2002-82485, and JP-A-2004-287149). However, in the above method, the usable resin is limited to one having high self-emulsifiability such as a specific polyester resin having a sulfone group. In addition, as the self-emulsifiable resin has a large number of dissociative terminal groups, for example, when it is used as electrophotographic toner, the hydrophobic level of the resin decreases and the charging characteristics, water-adsorption property, and the like may be then affected.

There is another known method in which resin being dissolved at high temperature is mixed with an aqueous medium containing a neutralizing agent at high pressure, and then the mixture is subjected to a shearing force, thereby producing an aqueous dispersion of resin fine particles (see, for example, JP-A-2000-191892, and JP-A-2002-256077). In this method, however, no dispersant such as a surfactant is included basically. Thus, the protective force of fine particles thus formed (e.g., three-dimensional shielding force) is poor. Therefore, the particles may tend to combine with each other in emulsification under pressurization heating and the desired particle diameters are hardly obtained, or a problem of broadening the distribution of particle diameters tends to occur.

There is a proposal to obtain an aqueous dispersion, in which a neutralizing agent is added to a resin upon melting the resin by heat and the contact addition of an aqueous medium is then carried out while a melting state is kept (see, for example, JP-A-2006-1.8227).

However, in this method, an aqueous dispersion is hardly obtainable from a resin with a comparatively high softening point.

There is another proposed method of manufacturing an aqueous dispersion of resin fine particles in a system using an emulsifying agent (see, for example, JP-A-2004-189765). In this method, however, rapid cooling is carried out after processing at high temperature under high pressure, so that particles tends to combine with each other and the grain size distribution of the obtained resin fine particles is broadened. Thus, problems tend to occur such that the desired particle diameter may be hardly obtained and the distribution of particle diameters may be broadened.

A method of manufacturing an aqueous dispersion of resin fine particles in an aqueous medium with the application of constrained pressure under heat has been proposed (see, for example, JP-A-2005-330350). In this method, however, in the case of a resin having an acid group, hydrolysis occurs in the aqueous medium to bring about the possibility of a decrease in molecular weight.

### SUMMARY OF THE INVENTION

### Problems to be Solved by the Invention

The present invention intends to manufacture an aqueous dispersion of resin fine particles with a desired range of particle diameters and a narrow particle diameter distribution even in the case of a resin with a comparatively high softening temperature (Tm) without using an organic solvent for dispersing the resin in an emulsion dispersion method.

### Means for Solving the Problems

The object of the present invention can be attained by employing any of the following constructions:

(1) a method of manufacturing an aqueous dispersion of resin fine particles, including: a mixing step of mixing an aqueous medium, a resin having an acid group, a basic substance, and a surfactant to obtain a mixture; an emulsification step of applying a shearing force to the mixture while heating at temperature 10.0° C. or more higher than a softening temperature (Tm) of the resin having the acid group to obtain an emulsified product; and a cooling step of obtaining an aqueous dispersion of resin fine particles by cooling the emulsified product, in which, in the cooling step, cooling is carried out at a cooling rate of 0.5° C./min or more to 10.0° C./min or less to a glass transition temperature (Tg) of the resin having the acid group or lower while a shearing force is applied;

(2) a method of manufacturing an aqueous dispersion of resin fine particles according to the above item (1), in which the softening temperature of the resin having the acid group is 90.0° C. or higher to 150.0° C. or lower;

(3) a method of manufacturing an aqueous dispersion of resin fine particles according to the above item (1) or (2), in which the emulsification step is carried out under the conditions of 100.0° C. or higher and 0.11 MPa or more;

(4) a method of manufacturing an aqueous dispersion of resin fine particles according to any one of the above items (1) to (3), in which the resin having the acid group is a polyester resin;

(5) a method of manufacturing an aqueous dispersion of resin fine particles according to any one of the above items (1) to (4), in which a 50% particle diameter of the resin fine particles in terms of volume distribution is 0.02 μm or more to 1.00 μm or less;

(6) a method of manufacturing an aqueous dispersion of resin fine particles according to any one of the above items (1) to (5), in which, in a molecular weight distribution determined by gel permeation chromatography (GPC) of a tetrahydrofuran (THF)-soluble matter of the resin fine particles, a peak top of a main peak is present within a range of molecular weights from 3,500 or more to 15,000 or less, a weight average molecular weight is 5,000 or more to 50,000 or less, and the content of a component with a molecular weight of 500 or more but less than 2,000 is 0.1% or more to 20.0% or less of the total amount of all components;

(7) a method of manufacturing an aqueous dispersion of resin fine particles according to any one of the above items (1) to (6), in which the surfactant is at least one selected from the group consisting of nonionic surfactants and anionic surfactants;

(8) a method of manufacturing an aqueous dispersion of resin fine particles according to any one of the above items (1) to (7), in which the basic substance is amine;

(9) An aqueous dispersion of resin fine particles, which is obtainable by the method of manufacturing an aqueous dispersion of resin fine particles according to any one of the above items (1) to (8);

(10) a method of manufacturing toner, including: a aggregation step of mixing at least an aqueous dispersion of resin fine particles and a colorant to aggregate the resin fine particles and the colorant in an aqueous medium to form aggregates; and a fusion step of heating the aggregates to fuse together, in which the aqueous dispersion of resin fine particles is the aqueous dispersion of resin fine particles according to the above item (9); and

(11) A toner, which is obtainable by the method of manufacturing toner according to the above item (10).

### EFFECT OF THE INVENTION

According to the present invention, it becomes possible to manufacture an aqueous dispersion of resin fine particles with a desired range of particle diameters and a narrow particle diameter distribution even in the case of a resin with a comparatively high softening temperature (Tm) without using an organic solvent for dispersing the resin in an emulsion dispersion method.

### BEST MODE FOR CARRYING OUT THE INVENTION

a method of manufacturing an aqueous dispersion of resin fine particles of the present invention (which may hereinafter be referred to as “method of the present invention”) includes: a mixing step of mixing an aqueous medium, a resin having an acid group, a basic substance, and a surfactant to obtain a mixture; an emulsification step of applying a shearing force to the mixture while heating at temperature 10.0° C. or more higher than a softening temperature (Tm) of the resin having the acid group to obtain an emulsified product; and a cooling step of obtaining an aqueous dispersion of resin fine particles by cooling the emulsified product, and in which, in the cooling step, cooling is carried out at a cooling rate of 0.5° C./min or more to 10.0° C./min or less to a glass transition temperature (Tg) of the resin having the acid group or lower while a shearing force is applied. By employing such a method, an aqueous dispersion of resin fine particles with a molecular weight distribution suitable for the manufacture of electrophotographic toner with an emulsion aggregation method and with a 50% particle diameter of 0.02 μm or more to 1.00 μm or less in terms of volume distribution can be obtained.

First, materials used in the method of the present invention will be described.

<Resin with Acid Group Used in the Method of the Present Invention>

The resin having an acid group is not specifically limited as far as it is a resin suitable for toner having the following characteristics.

The resin having the acid group as described above is a resin having a carboxyl group, a sulfate ester group, or the like on the terminal, side chain, or the like of its molecular chain. A suitable example of such a resin may be a (meth)acryl resin, a styrene-(meth)acryl copolymer resin, a polyester resin, or the like. Of those resins, the polyester resin is particularly preferable because it can be provided with a small difference between the softening temperature (Tm) and glass transition temperature (Tg) thereof.

The softening temperature (Tm) of the resin having the acid group as described above is determined using a flow tester (CFT-500D, manufactured by Shimadzu Corporation). To be specific, 1.5 g of a sample (resin) for measurement is weighed and a die with a height of 1.0 mm and a diameter of 1.0 mm is used. The measurement is carried under the conditions of a rate of temperature increase is 4.0° C./min, a preheat time of 300 seconds, a load of 5 kg, and a measurement temperature range of 60.0 to 200.0° C. The temperature at which half of the above sample has flown out is defined as a softening temperature (Tm).

The softening temperature (Tm) of the resin having the acid group as described above is preferably in the range of 90.0° C. or higher to 150.0° C. or lower. In other words, for using the resin in electrophotographic toner, a temperature of 150.0° C. or lower is preferable from a viewpoint of fixability and also a temperature of 90.0° C. or higher is preferable from a viewpoint of heat-resistance storage ability.

The resin having the acid group as described above is preferably provided with the following physical properties (1) to (3) from the viewpoints of the heat-resistance storage ability, fixability, and offset resistance (inhibition of high-temperature offset and low-temperature offset) of toner and the expansion of a non-offset temperature range: it is preferable that (1) a glass transition temperature (Tg) be 50.0 to 70.0° C., (2) a number average molecular weight (Mn) be 1,000 to 50,000, more preferably 3,000 to 20,000, and (3) a molecular weight distribution (Mw/Mn) represented by a ratio of the number average molecular weight (Mn) with a weight average molecular weight (Mw) be 2 to 60.

Further, the above glass transition temperature (Tg) is a physical property value determined in reference to JIS K7121 and means an intermediate glass transition temperature as described in the above standard.

<Surfactant Used in the Method of the Present Invention>

Examples of the above surfactant include: anionic surfactant, such as those of sulfate salt, sulfonate salt, phosphate ester, and soap; cationic surfactants such as those of amine salt type and quaternary ammonium salt type; and nonionic surfactants such as those of polyethylene glycol, alkylphenol ethylene oxide adduct, and polyhydric alcohol. Among them, at least one selected from the group consisting of the nonionic surfactants and anionic surfactants can be preferably used. A nonionic surfactant may be used in combination with an anionic surfactant. The above surfactants may be used independently or in combination of two or more of them. The concentration of the above surfactant in an aqueous medium is preferably in the range of 0.5 to 5% by mass.

<Basic Substance Used in the Method of the Present Invention>

When a resin having an acid group is directly pulverized in an aqueous medium, the pH value becomes 3 to 4, shifting to the acidic side too much. For example, if a crystalline polyester resin is present or a resin having an acid group is a polyester resin, the resin may be hydrolyzed. In the method of the present invention, however, the presence of a basic substance leads to neutralize an aqueous medium, at a pH value of 6 to 8, at the time of obtaining an emulsified product, and a resin having an acid group can be then pulverized in the aqueous medium. Consequently, an aqueous dispersion can be obtained without hydrolysis of the resin.

Examples of the above basic substance include: inorganic bases such as ammonia, sodium hydroxide, potassium hydroxide, sodium carbonate, potassium carbonate, sodium hydrogen carbonate, and potassium hydrogen carbonate; and organic bases such as dimethyl amine, diethyl amine, and triethyl amine. Among them, from a viewpoint of preventing the occurrence of hydrolysis, weak basic amines such as dimethyl amine and triethyl amine are preferable.

It is preferable that the amount of the above basic substance added be suitably adjusted so as to adjust the pH of the aqueous medium to 6 to 8 when obtaining an emulsified product. The basic substance tends to lower the particle diameters of resin fine particles when the addition amount of the basic substance increases. In addition, the hydrolysis of a resin may occur even when the pH of the aqueous medium is shifted to basic. Therefore, in the case of using a strong base as a basic substance, there is a need of restricting the addition amount to prevent the hydrolysis from occurring.

Next, a method of manufacturing an aqueous dispersion of resin fine particles will be described.

The method of the present invention includes: a mixing step for obtaining a mixture by mixing an aqueous medium, a resin having an acid group, a basic substance, and a surfactant together; an emulsification step for obtaining an emulsified product by applying a shearing force to the above mixture while heating at temperature 10.0° C. or more higher than the softening temperature (Tm) of the above resin having the acid group; and a cooling step for obtaining an aqueous dispersion of resin fine particles by cooling the emulsified product. Specifically, first, a resin having an acid group is poured and mixed into an aqueous medium including a surfactant and a basic substance in a container which can be hermetically sealed and pressurized. Then, the resin is dispersed by applying a shearing force to the resin under hermetically sealing and pressurizing conditions while heating at temperature 10.0° C. or more higher than the softening temperature (Tm) of the resin, thereby obtaining an emulsified product. Further, the emulsified product thus obtained is cooled down to the glass transition temperature or lower of the rein at a cooling rate of 0.5° C./min or more to 10.0° C./min or less while a shearing force is applied to the emulsified product, thereby obtaining an aqueous dispersion of resin fine particles.

When the difference between the heating temperature and the softening temperature (Tm) of the resin in the above emulsification step is less than 10.0° C., the softening of the resin is insufficient. Thus, it becomes hard to obtain an emulsified product. Therefore, the heating temperature in the above emulsification step is set to temperature 10.0° C. or more higher than the softening temperature (Tm) of the resin. In addition, for obtaining a stabilized emulsified product, it is preferable to apply a shearing force while heating at temperature 15.0° C. or more higher than the softening temperature (Tm) of the resin having the acid group in the above-emulsification step.

Further, in the above emulsification step, it is preferable to apply the shearing force to the mixture while heating at temperature 10.0 to 100.0° C., more preferably 10.0 to 50.0° C., higher than the softening temperature (Tm) of the resin having the acid group.

By the way, in the present invention, when the resin having the acid group with a softening temperature of 90.0° C. or higher is used, the heating temperature in the emulsification step is 100.0° C. or higher. In this way, when the heating temperature in the emulsification step is 100.0° C. or higher, it is preferable to carry out the emulsification step in a container which can be hermetically sealed and pressurized under the pressurization conditions (preferably 0.11 MPa or more, more preferably 0.11 MPa or more to 4.00 MPa or less, particularly preferably 0.11 MPa or more to 1.60 MPa or less).

When the above time period of heating and pressurization is too short, a sharp distribution of particle diameters is hardly obtainable as the sizes of the respective emulsified products vary. Thus, the time period of heating and pressurization is preferably 10 minutes or more, more preferably 20 minutes or more.

In the present invention, the cooling rate in the cooling step of cooling the emulsified product thus obtained to the glass transition temperature (Tg) or lower of the resin having the acid group is in the range of 0.5° C./min or more to 10.0° C./min or less, preferably 1.0° C./min or more to 10.0° C./min or less, more preferably 1.0° C./min or more to 5.0° C./min or less. When the emulsified product is cooled at a cooling rate of more than 10.0° C./min, rough particles are generated and the grain size distribution of resin fine particles becomes broad (uneven). A colorant in toner particles becomes uneven if toner is manufactured by a aggregation method when the grain size distribution of resin fine particles is broad (uneven). Thus, a bad effect such as a decrease in density on printing may tend to occur. By the way, the cooling rate from the temperature of the above glass transition temperature (Tg) or lower to room temperature is not specifically limited.

The device used in the method of the present invention is not specifically limited as far as it is a device capable of applying a shearing force in a container which can bear high temperature and high pressure. The device for applying a shearing force may be a clear mix, a homomixer, a homogenizer, or the like.

<Aqueous Dispersion of Resin Fine Particles of the Present Invention>

The aqueous dispersion of resin fine particles of the present invention is obtainable by the method of the present invention.

The resin fine particles in the aqueous dispersion of resin fine particles which can be obtained by the method of the present invention (hereinafter, simply referred to as “resin fine particles of the present invention”) each have a 50% particle diameter of preferably 0.02 μm or more to 1.00 μm or less, more preferably 0.02 μm or more to 0.40 μm or less in terms of volume distribution.

When the above 50% particle diameter in terms of volume distribution exceeds 1.00 μm, the resin fine particles lose storage stability and tend to cause settling separation. In addition, when the resin fine particles are used as materials of toner which can be obtained by the emulsion aggregation method, the particle diameter of the toner is 3 to 7 μm. Thus, the presence of a large amount of particles each having a particle diameter of 1.00 μm or more leads to a difficulty in keeping the uniformity of the composition of the toner. The 50% particle diameter of each resin fine particle in terms of volume distribution is preferably 0.40 μm or less in consideration of the manufacture of toner.

For adjusting the above 50% particle diameter of each resin fine particle in terms of volume distribution to the above range, the amount of a surfactant, the amount of a basic substance, the heating temperature at the time of the emulsification step, and the strength of shearing force in the emulsification step and the cooling step may be desirably suitably adjusted.

The resin fine particles of the present invention preferably have the peak top of a main peak within a range of molecular weights from 3,500 or more to 15,000 or less in a molecular weight distribution of the tetrahydrofuran (THF)-soluble matter of the resin fine particles as determined by gel permeation chromatography (GPC). When the peak top of the main peak is present at less than 3,500, the resin fine particles have poor thermal stability. In addition, the aqueous dispersion with such resin fine particles tends to cause aggregation/separation at 40.0° C. or higher. Further, thermal stability of toner prepared by aggregating and combining such resin fine particles tends to worsen. On the other hand, when the peak top of the main peak exceeds 15,000, the toner obtained using such resin fine particles may hardly obtain low-temperature fixability.

Likewise, the weight average molecular weight Mw of the tetrahydrofuran (THF)-soluble matter of resin fine particles determined by gel permeation chromatography (GPC) is preferably 5,000 or more to 50,000 or less, more preferably 5,000 or more to 30,000 or less. When the above weight average molecular weight Mw is less than 5,000, the resin fine particles may show poor thermal stability. When the above weight average molecular weight Mw exceeds 50,000, the resulting toner may hardly obtain low-temperature fixability.

Further, the content of a component with a molecular weight of 500 or more but less than 2,000 determined by gel permeation chromatography (GPC) of the tetrahydrofuran (THF)-soluble matter of resin fine particles is preferably 0.1% or more to 20.0% or less, more preferably 0.1% or more to 15.0% or less with respect to the total amounts of all components. When the content of the above component with a molecular weight of 500 or more but less than 2,000 exceeds 20.0%, the toner obtained using such resin fine particles tends to have poor powder characteristics, particularly thermal stability.

<Method of Manufacturing Toner of the Present Invention>

Next, the method of manufacturing toner of the present invention will be described.

The method of manufacturing toner of the present invention includes: a aggregation step for forming aggregates by mixing at least an aqueous dispersion of resin fine particles with a colorant and aggregating the resin fine particles and the colorant in the aqueous medium; and a step of fusing the above aggregates by heating, and is in which the above aqueous dispersion of resin fine particles is the aqueous dispersion of resin fine particles of the present invention. In the method of manufacturing toner of the present invention, the constituent components of the toner may further include a charge control agent and a release agent, in addition to the above resin fine particles and the above colorant.

As the colorant, the following organic pigments and organic dyes are preferably mentioned.

For a cyan organic pigment or organic dye, a copper phthalocyanine compound and derivatives thereof, an anthraquinone compound, a lake compound of basic dyes, and the like may be used. Specific examples thereof include C.I. Pigment Blue 1, C.I. Pigment Blue 7, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 60, C.I. Pigment Blue 62, and C.I. Pigment Blue 66.

For a magenta organic pigment or organic dye, a condensed azo compound, a diketopyrrolopyrrole compound, anthraquinone, a quinacridone compound, a lake compound of basic dyes, a naphthol compound, a benzimidazolone compound, a thioindigo compound, a perylene compound, and the like may be used. Specific examples thereof include C.I. Pigment Red 2, C.I. Pigment Red 3, C.I. Pigment Red 5, C.I. Pigment Red 6, C.I. Pigment Red 7, C.I. Pigment Violet 19, C.I. Pigment Red 23, C.I. Pigment Red 48:2, C.I. Pigment Red 48:3, C.I. Pigment Red 48:4, C.I. Pigment Red 57:1, C.I. Pigment Red 81:1, C.I. Pigment Red 122, C.I. Pigment Red 144, C.I. Pigment Red 146, C.I. Pigment Red 166, C.I. Pigment Red 169, C.I. Pigment Red 177, C.I. Pigment Red 184, C.I. Pigment Red 185, C.I. Pigment Red 202, C.I. Pigment Red 206, C.I. Pigment Red 220, C.I. Pigment Red 221, and C.I. Pigment Red 254.

For a yellow organic pigment or organic dye, a compound typified by a condensed azo compound, an isoindolinone compound, an anthraquinone compound, an azo metallic complex, a methine compound, or an allylamide compound may be used. Specific examples thereof include C.I. Pigment Yellow 12, C.I. Pigment Yellow 13, C.I. Pigment Yellow 14, C.I. Pigment Yellow 15, C.I. Pigment Yellow 17, C.I. Pigment Yellow 62, C.I. Pigment Yellow 74, C.I. Pigment Yellow 83, C.I. Pigment Yellow 93, C.I. Pigment Yellow 94, C.I. Pigment Yellow 95, C.I. Pigment Yellow 97, C.I. Pigment Yellow 109, C.I. Pigment Yellow 110, C.I. Pigment Yellow 111, C.I. Pigment Yellow 120, C.I. Pigment Yellow 127, C.I. Pigment Yellow 128, C.I. Pigment Yellow 129, C.I. Pigment Yellow 147, C.I. Pigment Yellow 151, C.I. Pigment Yellow 154, C.I. Pigment Yellow 155, C.I. Pigment Yellow 168, C.I. Pigment Yellow 174, C.I. Pigment Yellow 175, C.I. Pigment Yellow 176, C.I. Pigment Yellow 180, C.I. Pigment Yellow 181, C.I. Pigment Yellow 191, and C.I. Pigment Yellow 194.

A black colorant to be used may be carbon black, a magnetic body, or a colorant toned to have a black color by using the above yellow, magenta, and cyan-based colorants.

One kind of those colorants can be used alone, or two or more kinds of them can be used as a mixture. Further, each of those colorants can be used in a solid solution state. The above colorant is selected in terms of hue angle, chroma, brightness, light resistance, OHP transparency, and dispersibility in the toner.

The amount of the above colorant to be added is preferably 1 to 20 parts by mass with respect to 100 parts by mass of the binder resin.

The above release agent is preferably one having a melting point of 150.0° C. or lower, more preferably 40.0° C. or higher to 130.0° C. or lower, particularly preferably 40.0° C. or higher to 110.0° C. or lower.

Examples of as the above release agent include: low-molecular-weight polyolefins such as polyethylene; silicones each having a melting point by heat; aliphatic amides such as oleic amide, erucic amide, ricinoleic amide, and stearic acid amide; ester waxes such as stearyl stearate; waxes derived from plants such as a carnauba wax, a rice wax, a candellila wax, a haze wax, and a jojoba wax; waxes derived from animals such as a bees wax; waxes derived from mineral or petroleum such as a montan wax, ozokerite, ceresin, a paraffin wax, a microcrystalline wax, a Fischer-Tropsch wax, and an ester wax; and modified products thereof.

The above release agent is preferably used in an amount of 1 to 20 parts by mass with respect to 100 parts by mass of the binder resin.

Examples of the above charge control agent include a quaternary ammonium salt compound, a nigrosin compound, and compounds composed of complexes of aluminum, iron, chromium, zinc, zirconium, and so on. Further, the above charge control agent is preferably one made of a material which hardly dissolves in water from the viewpoints of the control of ion strength having an influence on the stability when aggregating or fusing and wastewater recycling.

The above charge control agent is preferably used in an amount of 0.1 to 5 parts by mass with respect to 100 parts by mass of the binder resin from the viewpoint of a further improvement in charging property.

The method of manufacturing toner of the present invention is characterized by including: a aggregation step for forming aggregates by mixing an aqueous dispersion of resin fine particles with a colorant and optionally with a charge control agent, a release agent, or the like, and aggregating the resin fine particles, the colorant, and so on in the aqueous medium up to a desired particle diameter of toner; and a fusion step for fusing the aggregates by heating. The method of manufacturing toner of the present invention will be described in more detail. However, the present invention is not limited to the following method.

(Aggregation Step)

In the aggregation step, the aqueous dispersion of resin fine particles of the present invention is mixed with a colorant and other constituent components of toner such as a release agent to prepare a mixture solution. Subsequently, aggregates are formed in the mixture solution to prepare an aggregate-dispersing solution. The aggregates can be formed in the mixture solution by adding, for example, a pH adjuster, a flocculating agent, or an aggregate-stabilizing agent to the mixture solution, mixing the mixture solution and suitably applying temperature, mechanical motive energy, and so on.

Examples of the above pH adjuster include: alkalis such as ammonia and sodium hydroxide; and acids such as nitric acid and citric acid. Examples of the above flocculating agent include: monovalent metal salts of sodium, potassium, and the like; divalent metal salts of calcium, magnesium, and the like; trivalent metal salts of iron, aluminum, and the like; and alcohols such as methanol, ethanol, and propanol. The above aggregate-stabilizing agent may be mainly a surfactant itself or an aqueous medium containing such a surfactant.

The addition/mixing of the above flocculating agent or the like is preferably carried out at temperature not more than the glass transition temperature (Tg) of resin fine particles included in the mixture. When the above mixing is carried out under this temperature condition, the aggregation proceeds stably. The above mixing may be carried out using any of well-known mixing devices, specifically a homogenizer, a mixer, and so on.

In general, the average particle diameter of the aggregates formed herein, which is not particularly limited, is desirably controlled so as to be almost equal to the average particle diameter of toner to be obtained in ordinary cases. For example, the control can be easily carried out by suitably setting or changing the temperature and the above conditions of agitation mixing. In the aggregation step, aggregates having an average particle diameter almost equal to that of toner can be formed and an aggregate-dispersion solution is then prepared by dispersing the aggregates.

(Fusion Step)

The fusion step is a step for fusing the above aggregates by heating. Before the fusion step, the above pH adjuster, the above surfactant, or the like may be suitably added for preventing the fusion between toner particles.

The temperature of the heating has only to be in the range from the glass transition temperature (Tg) of the resin in the aggregates to the decomposition temperature of the resin.

For the time period of the heating, a short time suffices when the heating temperature is high, while a long time is required when the heating temperature is low. In other words, the time required for fusing the above aggregates is generally 30 minutes to 10 hours but not completely determined because it depends on the temperature of the above heating.

In the present invention, the toner obtained after the completion of the fusion step is subjected to washing, filtration, drying, and the like under appropriate conditions, thereby obtaining toner particles. Further, the surfaces of the resulting toner particles may be externally added with inorganic granules of silica, alumina, titania, calcium carbonate, or the like or resin particles of vinyl resin, polyester resin, silicone resin, or the like by applying a shearing force in a dry state. Those inorganic granules and resin particles each function as an external additive such as a flowable auxiliary agent or a cleaning auxiliary agent.

Hereinafter, the method of determining physical properties in the present invention will be described.

### <Determination of Molecular Weight Distribution, Weight Average Molecular Weight (Mw), Number Average Molecular Weight (Mn), or the Like of the Tetrahydrofuran (THF)-Soluble Matter of Resin or Resin Fine Particles by Gel Permeation Chromatography (GPC)>

The molecular weight distribution, weight average molecular weight (Mw), number average molecular weight (Mn), and so on of the THF-soluble matter of resin fine particles which can be determined by GPC are obtained as described below.

A column is stabilized in a heat chamber at 40° C. Tetrahydrofuran (THF) as a solvent is allowed to flow into the column at the above temperature at a flow rate of 1 ml/min, and about 100 μl of a THF solution (measurement sample) containing a resin or resin fine particles as a measurement target is injected for measurement. In measuring the molecular weight of the sample, the molecular weight distribution possessed by the sample is calculated from the relationship between a logarithmic value of an analytical curve prepared by several kinds of monodisperse polystyrene standard samples and the number of counts. Examples of the standard polystyrene samples for preparing an analytical curve that can be used include samples manufactured by TOSOH CORPORATION or by Showa Denko K.K. each having a molecular weight of about 10² to 10⁷. At least about ten standard polystyrene samples are suitably used. A refractive index (RI) detector is used as a detector. It is recommended that a combination of multiple commercially available polystyrene gel columns be used as the column. Examples of the combination include: a combination of shodex GPC KF-801, 802, 803, 804, 805, 806, 807, and 800P manufactured by Showa Denko K.K.; and a combination of TSK gel G1000H (HXL), G2000H (HXL), G3000H (HXL), G4000H (HXL), G5000H (HXL), G6000H (HXL), G7000H (HXL), and TSK guard column manufactured by TOSOH CORPORATION.

The measurement sample is produced as described below. A resin or (dried) resin fine particles is/are placed into tetrahydrofuran (THF), and the whole is left for several hours. After that, the resultant is sufficiently shaken and the sample is mixed with THF well (until the coalesced body of the sample disappears). Then, the resultant is left standing for an additional 12 hours or longer. In this case, the time period for which the resin or resin fine particles is/are is left in THF is set to 24 hours or longer. After that, the resultant is passed through a sample treatment filter (having a pore size of 0.2 to 0.5 μm, for example, a Myshori Disc H-25-2 manufactured by TOSOH CORPORATION and EKICRODISK 25 CR manufactured by Gelman Science Japan Co., Ltd. can be used), and is regarded as a measurement sample for GPC described above. In addition, a sample concentration is adjusted in such a manner that the concentration of a resin component is 0.5 to 5 mg/ml.

In addition, the prepared molecular weight distribution can lead to the molecular weight (Mp) at which the peak top of the main peak is present and the amount of the component in a molecular weight of 500 or more but less than 2,000 with respect to the total amount of all components. The amount of the component in a molecular weight of 500 or more but less than 2,000 with respect to the total amount of all components may be calculated by subtracting a frequency distribution cumulative value to a molecular weight of 500 from a frequency distribution cumulative value to a molecular weight of 2000.

<Determination of Acid Value of Resin Fine Particles>

The acid value of resin fine particles can be obtained as described below. Further, a basic operation is pursuant to JIS-K0070. The acid value means the mg number of potassium hydroxide required for neutralizing free fatty acid, resin acid, and so on in 1 g of resin fine particles provided as a measurement sample.

### (1) Reagents

(a) Solvent: an ethyl ether/ethyl alcohol mixture (1:1 or 2:1) or a benzene/ethyl alcohol mixture (1:1 or 2:1) is neutralized with an N/10 potassium hydroxide-ethyl alcohol solution with phenolphthalein as an indicator just before use.

(b) Phenolphthalein solution: 1 g of phenolphthalein is dissolved in 100 ml of ethyl alcohol (95% by volume).

(c) N/10 potassium hydroxide-ethyl alcohol solution: 7.0 g of potassium hydroxide is dissolved in the smallest possible amount of water, and ethyl alcohol (95% by volume) is added to make up 1 litter. Then, the mixture is left standing for 2 to 3 days, followed by filtration. The evaluation is carried out on the basis of JIS K8006 (to the basic point about titration under a content examination of a reagent).

### (2) Operation

Resin fine particles (measurement sample), 1 to 20 g, are properly weighed and then added with 100 ml of a solvent and several drops of a phenolphtalein solution as an indicator. Subsequently, the mixture is shaken well until the sample is completely dissolved.

In the case of a solid sample, the sample is dissolved by heating in a water bath. After cooling, it is titrated with the N/10 potassium hydroxide-ethyl alcohol solution and the end point of neutralization is then defined as a point at which the indicator shows color of fine red successively for 30 seconds.

### (3) Calculating Formula

The acid value is calculated by the following formula:

A=B×f×5.611/S

A: Acid value

B: The amount of N/10 potassium hydroxide-ethyl alcohol solution used (ml)

f: Factor of the N/10 potassium hydroxide-ethyl alcohol solution

S: Measurement sample (g)

<Measurement of Grain Size Distribution of Fine Particles Such as Resin Fine Particles>

The grain size distribution of fine particles such as resin fine particles is determined using a laser-diffraction/scattering grain size distribution analyzer (LA-920, manufactured by Horiba Ltd.) according to the operation manual of the analyzer.

Specifically, a measurement sample is adjusted to have a transmittance within a measurement range (70 to 95%) in the sample-introduction part of the above analyzer, followed by measuring a volume distribution.

The 50% particle diameter in terms of volume distribution is a particle diameter (median size) equivalent to accumulated 50%. The 95% particle diameter in terms of volume distribution is a particle diameter equivalent to accumulated 95% from the smaller one.

A variation coefficient is calculated according to the following formula:

Variation coefficient [%]=(arithmetic standard deviation/arithmetic average diameter)×100

<Measurement of Number Average Particle Diameter (D1) and Weight Average Particle Diameter (D4) of Toner>

The number average particle diameter (D1) and weight average particle diameter (D4) of the above toner are measured by a grain size distribution analysis with the Coulter method. The measuring device is a Coulter Counter TA-II or a Coulter Multisizer II (manufactured by Beckman Coulter, Inc), and the measurement is performed in accordance with the operation manual of the device. An electrolyte solution is a aqueous solution of sodium chloride having a concentration of about 1% prepared by using first grade sodium chloride. For example, an ISOTON R-II (manufactured by Coulter Scientific Japan, Co.) can be used as an electrolyte solution. A specific measurement method is as described below. 100 to 150 ml of the electrolyte aqueous solution is added with 0.1 to 5 ml of a surfactant, alkylbenzenesulfonate, as a dispersant. Further, 2 to 20 mg of a measurement sample (toner) is added to the mixture. The electrolyte solution in which the sample has been suspended is subjected to a dispersion treatment by using an ultrasonic dispersing unit for about 1 to 3 minutes. With respect to the obtained dispersion-treated solution, the volumes and number of toner each having a size of 2.00 μm or more are measured by using the measuring device provided with a 100-μm aperture as an aperture, and the volume distribution and number distribution of the toner are calculated. The number average particle diameter (D1) is determined from the number distribution of the toner and the weight average particle diameter (D4) is determined on the basis of weight from the volume distribution of the toner. (The central value of each channel is defined as a representative value for the channel.)

The channels to be used consist of 13 channels: 2.00 to 2.52 μm, 2.52 to 3.17 μm, 3.17 to 4.00 μm, 4.00 to 5.04 μm, 5.04 to 6.35 μm, 6.35 to 8.00 μm, 8.00 to 10.08 μm, 10.08 to 12.70 μm, 12.70 to 16.00 μm, 16.00 to 20.20 μm, 20.20 to 25.40 μm, 25.40 to 32.00 μm, and 32.00 to 40.30 μm.

### DESCRIPTION OF THE EMBODIMENTS

Hereinafter, the details of the present invention will be described with reference to examples. However, the aspects of the present invention are not limited to these examples.

### Example 1

A dispersed medium solution was prepared by dissolving 30 parts by mass of an anionic surfactant (Plysurf AL, manufactured by Dai-ichi Kogyo Seiyaku Co., Ltd.) and 25 parts by mass of N,N-dimethyl aminoethanol (basic substance) in 845 parts by mass of ion-exchanged water (aqueous medium). Then, 270 g of the dispersed medium solution was placed in a 350-ml pressure-resistant stainless steel container with a round bottom. Subsequently, 30 g of a pulverized product (1 to 2 mm in particle diameter) of “polyester resin A (type A)” ((composition (molar ratio)/polyoxypropylene (2.2)-2,2-bis(4-hydroxyphenyl)propane polyoxyethylene (2.0)-2,2-bis(4-hydroxyphenyl)propane:terephthalic acid fumaric acid:trimellitic acid=25:25:26:20:4), Mn; 3,500, Mw; 10,300, Mp; 8,700, Mw/Mn; 2.9, Tm; 96.0° C., Tg; 56.0° C., and an acid value of 11) was introduced and mixed.

Subsequently, a high-speed shearing emulsifier, Clearmix (CLM-2.2 S, manufactured by M-TECHNIQUE Co., Ltd.), was hermetically connected to the above pressure-resistant stainless steel container with a round bottom. The mixture in the container was sheared and dispersed with the Clearmix at a rotary frequency of its rotary of 18,000 r/min for 30 minutes while being heated and pressurized at 115.0° C. and 0.18 MPa. After that, until the temperature of the mixture reached 50.0° C., cooling was carried out at a cooling rate of 2.0° C./min while a rotation of 18,000 r/min was kept. Consequently, an aqueous dispersion 1 of resin fine particles with a 50% particle diameter of the resin fine particles of 0.09 μm in terms of volume distribution was obtained. The above conditions and the results thus obtained are represented in Table 1. Further, in the present invention, the pressure of the inside of the above container is a numeric value represented on a pressure gauge attached on the above container. The numeric value of the pressure gauge represents the value of an additional pressure value in addition to the atmospheric pressure. For example, it can be represented as 0 (zero) when the pressure applied is only the atmospheric pressure.

### Example 2

An aqueous dispersion 2 of resin fine particles with a 50% particle diameter of the resin fine particles of 0.12 μm in terms of volume distribution was obtained in a manner similar to Example 1 except that 30 parts by mass of an anionic surfactant (Plysurf AL, manufactured by Dai-ichi Kogyo Seiyaku Co., Ltd.) was replaced with 20 parts by mass of a nonionic surfactant (Noigen EA-137, manufactured by Dai-ichi Kogyo Seiyaku Co., Ltd.), and the amount of ion-exchanged water was changed to 855 parts by mass. The above conditions and the results thus obtained are represented in Table 1.

### Example 3

An aqueous dispersion 3 of resin fine particles with a 50% particle diameter of the resin fine particles of 0.12 μm in terms of volume distribution was obtained in a manner similar to Example 2 except that 25 parts by mass of N,N-dimethyl aminoethanol was replaced with 70 parts by mass of a 5N aqueous potassium hydroxide solution and the amount of ion-exchanged water was changed to 810 parts by mass. The above conditions and the results thus obtained are represented in Table 1.

### Example 4

A dispersed medium solution was prepared by dissolving 20 parts by mass of a nonionic surfactant (Noigen EA-137, manufactured by Dai-ichi Kogyo Seiyaku Co., Ltd.) and 35 parts by mass of triethylamine (basic substance) in 845 parts by mass of ion-exchanged water. Then, 270 g of the dispersed medium solution was placed in a 350-ml pressure-resistant stainless steel container with a round bottom. Subsequently, 30 g of a pulverized product (1 to 2 mm in particle diameter) of “polyester resin B (type B)” ((composition (molar ratio)/polyoxypropylene (2.2)-2,2-bis(4-hydroxyphenyl)propane ethylene glycol:terephthalic acid:maleic acid:trimellitic acid=35:15:33:15:2), Mn; 4,600, Mw; 16,500, Mp; 10,400, Mw/Mn; 3.6, Tm; 117.0° C., Tg; 67.0° C., and an acid value of 13) was introduced and mixed.

Subsequently, a high-speed shearing emulsifier, Clearmix (CLM-2.2 S, manufactured by M-TECHNIQUE Co., Ltd.), was hermetically connected to the above pressure-resistant stainless steel container with a round bottom. The mixture in the container was sheared and dispersed with the Clearmix at a rotary frequency of its rotor of 18,000 r/min for 30 minutes while being heated and pressurized at 140.0° C. and 0.36 MPa. After that, until the temperature of the mixture reached 50.0° C., cooling was carried out at a cooling rate of 1.0° C./min while a rotation of 18,000 r/min was kept. Consequently, an aqueous dispersion 4 of resin fine particles with a 50% particle diameter of the resin fine particles of 0.11 μm in terms of volume distribution was obtained. The above conditions and the results thus obtained are represented in Table 1.

### Example 5

An aqueous dispersion 5 of resin fine particles with a 50% particle diameter of the resin fine particles of 0.17 μm in terms of volume distribution was obtained in a manner similar to Example 4 except that 35 parts by mass of triethylamine was replaced with 20 parts by mass of N,N-dimethyl aminoethanol, the amount of ion-exchanged water was changed to 860 parts by mass, the heating and pressurization were performed at 130.0° C. and 0.26 MPa, the shearing time was changed to 60 minutes, and the cooling rate was changed to 2.0° C./min. The above conditions and the results thus obtained are represented in Table 1.

### Example 6

An aqueous dispersion 6 of resin fine particles with a 50% particle diameter of the resin fine particles of 0.30 μm in terms of volume distribution was obtained in a manner similar to Example 2 except that the addition amount of the nonionic surfactant (Noigen EA-137, manufactured by Dai-ichi Kogyo Seiyaku Co., Ltd.) was changed to 15 parts by mass and the amount of ion-exchanged water was changed to 860 parts by mass. The above conditions and the results thus obtained are represented in Table 2.

### Example 7

An aqueous dispersion 7 of resin fine particles with a 50% particle diameter of the resin fine particles of 0.63 μm in terms of volume distribution was obtained in a manner similar to Example 2 except that the addition amount of the nonionic surfactant (Noigen EA-137, manufactured by Dai-ichi Kogyo Seiyaku Co., Ltd.) was changed to 10 parts by mass, the amount of ion-exchanged water was changed to 865 parts by mass, and the cooling rate was changed to 4.0° C./min. The above conditions and the results thus obtained are represented in Table 2.

### Example 8

An aqueous dispersion 8 of resin fine particles with a 50% particle diameter of the resin fine particles of 0.12 μm in terms of volume distribution was obtained in a manner similar to Example 2 except that the cooling rate was changed to 8.0° C./min. The 50% particle diameter (D50) of the resin fine particles in terms of volume distribution was equal to that of the aqueous dispersion 2 of resin fine particles. However, the resin fine particles included large particles and showed a 95% particle diameter (D95) of 0.26 μm in terms of volume distribution, showing a variation coefficient as large as 54%. The above conditions and the results thus obtained are represented in Table 2.

### Example 9

An aqueous dispersion 9 of resin fine particles with a 50% particle diameter of the resin fine particles of 0.13 μm in terms of volume distribution was obtained in a manner similar to Example 4 except that “polyester resin A” was replaced with a “styrene/n-butyl acrylate/acrylic acid copolymer resin (type C)” ((composition (molar ratio)/styrene:n-butyl acrylate:acrylic acid (1)=72:27:1), Mn; 3,400, Mw; 14,700, Mp; 9,800, Mw/Mn; 4.3, Tm: 120.0° C., Tg; 59.0° C., and an acid value of 13) and the heating and pressurization were performed at 145.0° C. and 0.41 MPa. The above conditions and the results thus obtained are represented in Table 2.

### Example 10

An aqueous dispersion 10 of resin fine particles with a 50% particle diameter of the resin fine particles of 0.14 μm in terms of volume distribution was obtained in a manner similar to Example 2 except that the cooling rate was changed to 0.5° C./min. The particle diameter of each of the resin fine particles was slightly larger than that of the aqueous dispersion 2 of resin fine particles. The above conditions and the results thus obtained are represented in Table 2.

### Comparative Example 1

A dispersed medium solution was prepared by dissolving 30 parts by mass of an anionic surfactant (Plysurf AL, manufactured by Dai-ichi Kogyo Seiyaku Co., Ltd.) and 35 parts by mass of 28 w/v % (ammonia content) (a ratio of 28 g to 100 ml) ammonia water (basic substance) in 835 parts by mass of ion-exchanged water (aqueous medium). Then, 270 g of the dispersed medium solution was placed in a 350-ml pressure-resistant stainless steel container with a round bottom. Subsequently, 30 g of “polyester resin A (type A)” was introduced and mixed. Subsequently, a high-speed shearing emulsifier, Clearmix (CLM-2.2 S, manufactured by M-TECHNIQUE Co., Ltd.), was hermetically connected to the above pressure-resistant stainless steel container with a round bottom. The mixture in the container was sheared and dispersed with the Clearmix with a rotary frequency of its rotor of 18,000 r/min for 90 minutes while being heated at 95.0° C. After that, cooling was carried out at a cooling rate of 2.0° C./min until the mixture was cooled to room temperature, followed by taking out. However, emulsified particles could not be obtained. The above conditions and the results thus obtained are represented in Table 3.

### Comparative Example 2

A dispersed medium solution was prepared by dissolving 20 parts by mass of a nonionic surfactant (Noigen EA-137, manufactured by Dai-ichi Kogyo Seiyaku Co., Ltd.) and 25 parts by mass of N,N-dimethyl aminoethanol (basic substance) in 855 parts by mass of ion-exchanged water (aqueous medium). Then, 270 g of the dispersed medium solution was placed in a 350-ml pressure-resistant stainless steel container with a round bottom. Subsequently, 30 g of “polyester resin A (type A)” was introduced and mixed. Subsequently, a high-speed shearing emulsifier, Clearmix (CLM-2.2 S, manufactured by M-TECHNIQUE Co., Ltd.), was hermetically connected to the above pressure-resistant stainless steel container with a round bottom. The mixture in the container was sheared and dispersed with the Clearmix at a rotary frequency of its rotor of 18,000 r/min for 90 minutes while being heated and pressurized at 105.0° C. and 0.13 MPa. After that, cooling was carried out at a cooling rate of 2.0° C./min until the mixture was cooled to room temperature, followed by taking out. However, emulsified particles could not be obtained. The above conditions and the results thus obtained are represented in Table 3.

### Comparative Example 3

A dispersed medium solution was prepared by dissolving 30 parts by mass of an anionic surfactant (Neogen RK, manufactured by Dai-ichi Kogyo Seiyaku Co., Ltd.) into 870 parts by mass of ion-exchanged water (aqueous medium). Then, 270 g of the dispersed medium solution was placed in a 350-ml pressure-resistant stainless steel container with a round bottom. Further, 30 g of “polyester resin A (type A)” was introduced and mixed. Subsequently, a high-speed shearing emulsifier, Clearmix (CLM-2.2 S, manufactured by M-TECHNIQUE Co., Ltd.), was hermetically connected to the above pressure-resistant stainless steel container with a round bottom. The mixture in the container was sheared and dispersed with the Clearmix at a rotary frequency of its rotor of 18,000 r/min for 30 minutes while being heated and pressurized at 130.0° C. and 0.26 MPa. After that, cooling was carried out at a cooling rate of 2.0° C./min until the mixture was cooled to 50.0° C. while a rotation of 18,000 r/min was kept. As a result, an aqueous dispersion 13 of resin fine particles with a 50% particle diameter of the resin fine particles of 0.73 μm in terms of volume distribution and a variation coefficient of 69% was obtained. The above conditions and the results thus obtained are represented in Table 3.

### Comparative Example 4

A dispersed medium solution was prepared by dissolving 30 parts by mass of an anionic surfactant (Plysurf AL, manufactured by Dai-ichi Kogyo Seiyaku Co., Ltd.) and 100 parts by mass of a 5N aqueous potassium hydroxide solution (basic substance) in 770 parts by mass of ion-exchanged water (aqueous medium). Then, 270 g of the dispersed medium solution was placed in a 350-ml pressure-resistant stainless steel container with a round bottom. Further, 30 g of “polyester resin A (type A)” was introduced and mixed. Subsequently, a high-speed shearing emulsifier, Clearmix (CLM-2.2S, manufactured by M-TECHNIQUE Co., Ltd.), was hermetically connected to the above pressure-resistant stainless steel container with a round bottom. The mixture in the container was sheared with the Clearmix at a rotary frequency of its rotor of 18,000 r/min for 30 minutes while being heated and pressurized at 140.0° C. and 0.36 MPa. After that, cooling was carried out at a cooling rate of 2.0° C./min until the mixture was cooled to 50.0° C. while a rotation of 18,000 r/min was kept. As a result, an aqueous dispersion 14 of resin fine particles with a 50% particle diameter of the resin fine particles of 0.11 r/min terms of volume distribution was obtained. The above conditions and the results thus obtained are represented in Table 3.

### Comparative Example 5

An aqueous dispersion 15 of resin fine particles with a 50% particle diameter of the resin fine particles of 0.24 μm in terms of volume distribution and a variation coefficient of 134% was obtained in a manner similar to Example 2 except that the cooling rate was changed to 20.0° C./min. The above conditions and the results thus obtained are represented in Table 3.

Further, the molecular weight distributions of the resin fine particles in Tables 1 to 3 were determined after the resulting aqueous dispersions of resin fine particles had been air-dried.

TABLE 1

| Example No. | | | 1 | 2 | 3 | 4 | 5 |
|---|---|---|---|---|---|---|---|
| Resin with | Type | | A | A | A | B | B |
| acid group | Softening temperature [° C.] | | 96.0 | 96.0 | 96.0 | 117.0 | 117.0 |
| | Molecular weight | Mp | 8,700 | 8,700 | 8,700 | 10,400 | 10,400 |
| | distribution of | Percentage of component of 500 or more but | 10 | 10 | 10 | 7 | 7 |
| | THF-soluble | less than 2,000 [%] | | | | | |
| | matter | | | | | | |
| | Concentration [% by mass] | | 10 | 10 | 10 | 10 | 10 |
| Surfactant | | Type | Anion D | Nonion F | Nonion F | Nonion F | Nonion F |
| | | Concentration [% by mass] | 3.0 | 2.0 | 2.0 | 2.0 | 2.0 |
| Basic substance | | Type | Amine G | Amine G | KOH | Amine H | Amine G |
| | | Concentration [% by mass] | 2.5 | 2.5 | 7.0 | 3.5 | 2.0 |
| Process conditions | | Heating temperature [° C.] | 115.0 | 115.0 | 115.0 | 140.0 | 130.0 |
| | | Pressure [MPa] | 0.18 | 0.18 | 0.18 | 0.36 | 0.26 |
| | | Cooling rate [° C./min] | 2.0 | 2.0 | 2.0 | 1.0 | 2.0 |
| Resin fine | Grain size | D50 [μm] | 0.09 | 0.12 | 0.12 | 0.11 | 0.17 |
| particles | distribution | D95 [μm] | 0.14 | 0.17 | 0.16 | 0.15 | 0.25 |
| | | Variation coefficient [%] | 23 | 18 | 17 | 15 | 22 |
| | Molecular weight | Mp | 8,200 | 8,300 | 7,800 | 9,800 | 10,000 |
| | distribution of | Percentage of component of 500 or more but | 15 | 12 | 19 | 15 | 12 |
| | THF-soluble | less than 2,000 [%] | | | | | |
| | matter | | | | | | |

Anion D: Plysurf AL
Nonion F: Noigen EA-137
Amine G: N,N-dimethyl aminoethanol
Amine H: Triethylamine
KOH: 5N aqueous potassium hydroxide solution

TABLE 2

| Example No. | | | 6 | 7 | 8 | 9 | 10 |
|---|---|---|---|---|---|---|---|
| Resin with | Type | | A | A | A | C | A |
| acid group | Softening temperature [° C.] | | 96.0 | 96.0 | 96.0 | 120.0 | 96.0 |
| | Molecular weight | Mp | 8,700 | 8,700 | 8,700 | 9,800 | 8,700 |
| | distribution of | Percentage of component of 500 or | 10 | 10 | 10 | 12 | 10 |
| | THF-soluble matter | more but less than 2,000 [%] | | | | | |
| | Concentration [% by mass] | | 10 | 10 | 10 | 10 | 10 |
| Surfactant | | Type | Nonion F | Nonion F | Nonion F | Nonion F | Nonion F |
| | | Concentration [% by mass] | 1.5 | 1.0 | 2.0 | 2.0 | 2.0 |
| Basic substance | | Type | Amine G | Amine G | Amine G | Amine H | Amine G |
| | | Concentration [% by mass] | 2.5 | 2.5 | 2.5 | 3.5 | 2.5 |
| Process conditions | | Heating temperature [° C.] | 115.0 | 115.0 | 115.0 | 145.0 | 115.0 |
| | | Pressure [MPa] | 0.18 | 0.18 | 0.18 | 0.41 | 0.18 |
| | | Cooling rate [° C./min] | 2.0 | 4.0 | 8.0 | 1.0 | 0.5 |
| Resin fine | Grain size | D50 [μm] | 0.30 | 0.63 | 0.12 | 0.13 | 0.14 |
| particles | distribution | D95 [μm] | 0.43 | 0.96 | 0.26 | 0.18 | 0.18 |
| | | Variation coefficient [%] | 21 | 26 | 54 | 19 | 19 |
| | Molecular weight | Mp | 8,300 | 8,300 | 8,300 | 9,500 | 8,200 |
| | distribution of | Percentage of component of 500 or | 12 | 12 | 12 | 14 | 14 |
| | THF-soluble matter | more but less than 2,000 [%] | | | | | |

Nonion F: Noigen EA-137
Amine G: N,N-dimethyl aminoethanol
Amine H: Triethylamine

TABLE 3

| Comparative Example No. | | | 1 | 2 | 3 | 4 | 5 |
|---|---|---|---|---|---|---|---|
| Resin with | Type | | A | A | A | A | A |
| acid group | Softening temperature [° C.] | | 96.0 | 96.0 | 96.0 | 96.0 | 96.0 |
| | Molecular weight | Mp | 8,700 | 8,700 | 8,700 | 8,700 | 8,700 |
| | distribution of | Percentage of component of | 10 | 10 | 10 | 10 | 10 |
| | THF-soluble | 500 or more but less than | | | | | |
| | matter | 2,000 [%] | | | | | |
| | Concentration [% by mass] | | 10 | 10 | 10 | 10 | 10 |
| Surfactant | | Type | Anion D | Nonion F | Anion E | Anion D | Nonion F |
| | | Concentration [% by mass] | 3.0 | 2.0 | 3.0 | 3.0 | 2.0 |
| Basic substance | | Type | Ammonia | Amine G | None | KOH | Amine G |
| | | | water | | | | |
| | | Concentration [% by mass] | 3.5 | 2.5 | 0.0 | 10.0 | 2.5 |
| Process conditions | | Process temperature [° C.] | 95.0 | 105.0 | 130.0 | 140.0 | 115.0 |
| | | Pressure [MPa]. | 0 | 0.13 | 0.26 | 0.36 | 0.18 |
| | | Cooling rate [° C./min] | 2.0 | 2.0 | 2.0 | 2.0 | 20.0 |
| Resin fine | Grain size | D50 [μm] | Resin fine | Resin fine | 0.73 | 0.11 | 0.24 |
| particles | distribution | D95 [μm] | particles | particles | 2.00 | 0.15 | 0.44 |
| | | Variation coefficient [%] | could not be | could not be | 69 | 15 | 134 |
| | Molecular weight | Mp | obtained | obtained | 5,900 | 4,500 | 8,300 |
| | distribution of | Percentage of component of | | | 42 | 28 | 12 |
| | THF-soluble matter | 500 or more but less than | | | | | |
| | | 2000 [%] | | | | | |

Anion D: Plysurf AL
Amine G: N,N-dimethyl aminoethanol
Anion E: Neogen RK
KOH: 5N aqueous potassium hydroxide solution
Nonion F: Noigen EA-137
Ammonia water: 28 w/v % (ammonia content)

Next, the following description will describe the manufacturing method including: a aggregation step in which at least the above aqueous dispersion of resin fine particles and the colorant are mixed together, and the resin fine particles and the colorant are then aggregated in the aqueous medium to form aggregates; and a fusion step in which the aggregates are fused together by heating, and also describe toner manufactured by the method.

### Production Example 1 of Toner

### Preparation of Release-Agent Dispersing Liquid

Paraffin wax (HNP9, melting point: 77.0° C., manufactured by Nippon Seiro Co., Ltd.,) 100 parts by mass
Anionic surfactant (Neogen RK, manufactured by Dai-ichi Kogyo Seiyaku Co., Ltd.) 20 parts by mass
Ion-exchanged water 880 parts by mass

A release-agent dispersing liquid was prepared by carrying out a dispersion process with a gaulin high-pressure homogenizer (SMT Co., Ltd.) after heating the above components at 95.0° C. and dispersing them with a homogenizer (ULTRA TURRAX T50, manufactured by IKA Co., Ltd.). The 50% particle diameter of the release agent in terms of volume distribution in this release-agent dispersing liquid was 0.22 μm, and the concentration of the release agent in the release-agent dispersing liquid was 10% by mass.

### <Preparation of Colorant Dispersing Liquid>

Magenta pigment (C.I. Pigment Red 122) 100 parts by mass
Anionic surfactant (Neogen RK, manufactured by Dai-ichi Kogyo Seiyaku Co., Ltd.) 15 parts by mass
Ion-exchanged water 885 parts by mass

A colorant dispersing liquid obtained by dispersing a colorant (magenta pigment) was prepared by mixing the above components and then dispersing the mixture with a high-pressure shock dispersing unit Nanomizer (manufactured by Yoshida Machinery Co., Ltd.) for 1 hour. The 50% particle diameter of the colorant (magenta pigment) in terms of volume distribution in this colorant dispersing liquid was 0.15 μm, and the concentration of the colorant in the colorant dispersing liquid was 10% by mass.

### <Preparation of Charge-Control Agent Dispersing Liquid>

Metal compound of dialkyl salicylic acid 200 parts by mass (Charge control agent, Bontron E-84, manufactured by Orient Chemical Industries Co., Ltd.)
Anionic surfactant 20 parts by mass (Neogen RK, manufactured by Dai-ichi Kogyo Seiyaku Co., Ltd.)
Ion-exchanged water 780 parts by mass

A charge control-agent dispersing liquid was prepared by mixing the above components and dispersing the mixture with a sand grinder mill to disperse the charge control agent. The 50% particle diameter of the charge control agent in terms of volume distribution in this charge control-agent dispersing liquid was 0.20 μm, and the concentration of the charge control agent in the charge control-agent dispersing liquid was 20% by mass.

### <Preparation of Mixture Solution>

Aqueous dispersion 1 of resin fine particles 1,000 parts by mass
The above colorant particle dispersing liquid 50 parts by mass
The above release-agent particle dispersing liquid 70 parts by mass

The above components were introduced into a 1-litter separable flask equipped with a stirring device, a cooling pipe, and a thermometer and then stirred, thereby obtaining a mixture solution.

### <Step for Forming Aggregated Particles>

The mixture was dropwisely added with 330 parts by mass of a 10% aqueous sodium chloride solution as a flocculating agent and then heated up to 50.0° C. in a heating oil bath while the contents of the flask was stirred. When the temperature reached 50.0° C., 3 parts by mass the aqueous dispersion 1 of resin fine particles and 10 parts by mass of the above charge control-agent dispersing liquid were further added to the flask. Subsequently, after the aggregated particles thus formed had been retained at 57.0° C. for 1 hour, the volume average particle diameter of the aggregated particles thus formed was determined using a flow-type particle-image analyzer (FPIA-3000, Sysmex Corporation) according to the operation manual of the device. As a result, the formation of aggregated particles 1 with a volume average particle diameter of 5.1 μm was confirmed.

### <Fusion Step>

After that, 3 parts by mass of an anionic surfactant (Neogen RK, manufactured by Dai-ichi Kogyo Seiyaku Co., Ltd.) was further Added thereto and then the mixture was heated up to 75.0° C. and retained for 3 hour while being continuously stirred, followed by cooling. The reaction product was filtrated and then washed with ion-exchanged water sufficiently, followed by drying. Consequently, toner particles 1 were obtained.

The toner particles 1 were subjected to measurement with the above Coulter Multisizer II (manufactured by Beckman Coulter, Inc.), resulting in a weight average particle diameter D4 of 5.31 μm and a number average particle diameter D1 of 4.40 μm. In other words, D4/D1 is 1.21 and the toner particles 1 represent a sharp grain size distribution.

Next, the toner particles 1 were mixed with 1.7% by mass of hydrophobic silica fine particles having a BET specific surface area of 200 m²/g (0.01 μm in average primary particle diameter), thereby preparing a toner 1 of the present invention.

### Production Examples 2 to 10 of Toners

Toners 2 to 10 were each prepared in a manner similar to the production example 1 of toner except that the aqueous dispersion 1 of resin fine particles was replaces with any one of the aqueous dispersions 2 to 10 of resin fine particles in the step of preparing a mixture solution.

### Production Examples 1 to 3 of Comparative Toners

Comparative toners 1 to 3 were each prepared in a manner similar to the production example 1 of toner except that the aqueous dispersion 1 of resin fine particles was replaced with any one of the aqueous dispersions 13 to 15 of resin fine particles in the step of preparing a mixture solution.

Evaluation results of the grain size distributions and so on of the above toners 1 to 10 and the comparative toners 1 to 3 are represented in Tables 4 and 5.

### Examples 11 to 20 and Comparative Examples 6 to 8

The following evaluations were carried out using the above toners 1 to 10 and comparative toners 1 to 3. The results are represented in Tables 4 and 5.

(Evaluation of Blocking Property)

The above respective toners were left standing in an incubator at a regulated temperature of 50° C. for 24 hrs and then evaluated for the degree of blocking.

∘: Blocking does not occur.

Δ: Blocking occurs, but dispersion easily occurs by force.

x: Blocking occurs, and dispersion does not occur even by force.

(Evaluation of Image Density)

Image formation was carried out under normal temperature and normal humidity using a commercially-available color laser printer (LBP-5500, manufactured by Canon Inc.) modified such that a process speed was doubled and a magenta cartridge was filled with each of the above toners and regular paper (color laser copia paper, manufactured by Canon Inc.). The resulting image was subjected to measurement with a Macbeth RD-918 and the relationship between the amount of toner on the transfer paper and the image density was determined. In particular, the image density was comparatively evaluated using a Macbeth density level corresponding to a toner amount of 0.5 mg/cm² on the transfer paper.

### [Macbeth Density Level]

1.3 or more . . . A

1.2 or more but less than 1.3 . . . B

1.0 or more but less than 1.2 . . . C

Less than 1.0 . . . D

(Evaluation of Fixability)

A two-component developer was prepared by mixing each of the above toners with ferrite carriers (average particle diameter of 42 μm) surface-coated with silicon resin so that the toner concentration could be 6% by mass. A commercially-available full-color digital copier (CLC1100, manufactured by Canon Inc.) was used and an unfixed toner image (0.6 mg/cm²) was then formed on image-receiving paper (64 g/m²). A fixing unit removed from a commercially-available color laser printer (LBP-5500, manufactured by Canon Inc.) was modified so that a fixing temperature could be adjusted and the modified unit was then used for carrying out a fixing test of the unfixed image. Under normal temperature and normal humidity a process speed was set to 100 mm/second, and the setting temperature was then set to nine, different points with intervals of 10° C. in the range of 140° C. to 220° C. The situation of offset when the unfixed image was fixed was visually evaluated.

[Fixing Temperature Region where No Offset Occurs]

<140 to 220° C./all nine points>

5 points or more . . . A: Good

3′ to 4 points . . . B: Slightly inferior

2 points or less . . . C: Bad

TABLE 4

| Example | | 11 | 12 | 13 | 14 | 15 | 16 | 17 | 18 | 19 | 20 |
|---|---|---|---|---|---|---|---|---|---|---|---|
| Toner No. | | 1 | 2 | 3 | 4 | 5 | 6 | 7 | 8 | 9 | 10 |
| Aqueous dispersion of resin fine | | 1 | 2 | 3 | 4 | 5 | 6 | 7 | 8 | 9 | 10 |
| particles No. | | | | | | | | | | | |
| Grain size | D4 [μm] | 5.31 | 5.12 | 5.23 | 5.14 | 5.13 | 5.11 | 5.18 | 5.08 | 5.1 | 5.15 |
| distribution | D4/D1 | 1.21 | 1.21 | 1.21 | 1.22 | 1.22 | 1.23 | 1.27 | 1.25 | 1.22 | 1.21 |

| | | | | | | | | | | |
|---|---|---|---|---|---|---|---|---|---|---|
| Blocking property | ∘ | ∘ | Δ | ∘ | ∘ | ∘ | ∘ | ∘ | ∘ | ∘ |
| Image density | A | A | A | A | A | A | B | A | A | A |
| Fixability | A | A | B | A | A | A | A | A | A | A |

TABLE 5

| Comparative Example | | 6 | 7 | 8 |
|---|---|---|---|---|
| Comparative toner No. | | 1 | 2 | 3 |
| Aqueous dispersion of resin fine | | 13 | 14 | 15 |
| particles No. | | | | |
| Grain size | D4 [μm] | 5.14 | 5.11 | 5.52 |
| distribution | D4/D1 | 1.31 | 1.23 | 1.33 |

| | | | |
|---|---|---|---|
| Blocking property | x | x | ∘ |
| Image density | D | A | C |
| Fixability | C | C | A |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-037656, filed Feb. 19, 2007, which is hereby incorporated by reference herein in its entirety.

What is claimed is:

1. A method of manufacturing an aqueous dispersion of resin fine particles, comprising:
a mixing step of mixing an aqueous medium, a resin having an acid group, a basic substance, and a surfactant to obtain a mixture;
an emulsification step of applying a shearing force to the mixture while heating at temperature 10.0° C. or more higher than a softening temperature (Tm) of the resin having the acid group to obtain an emulsified product; and
a cooling step of obtaining an aqueous dispersion of resin fine particles by cooling the emulsified product,
wherein, in the cooling step, cooling is carried out at a cooling rate of 0.5° C./min or more to 10.0° C./min or less to a glass transition temperature (Tg) of the resin having the acid group or lower while a shearing force is applied.

2. A method of manufacturing an aqueous dispersion of resin fine particles according to claim 1, wherein the softening temperature of the resin having the acid group is 90.0° C. or higher to 150.0° C. or lower.

3. A method of manufacturing an aqueous dispersion of resin fine particles according to claim 1, wherein the emulsification step is carried out under conditions of 100.0° C. or higher and 0.11 MPa or more.

4. A method of manufacturing an aqueous dispersion of resin fine particles according to claim 1, wherein the resin having the acid group comprises a polyester resin.

5. A method of manufacturing an aqueous dispersion of resin fine particles according to claim 1, wherein a 50% particle diameter of the resin fine particles in terms of volume distribution is 0.02 μm or more to 1.00 μm or less.

6. A method of manufacturing an aqueous dispersion of resin fine particles according to claim 1, wherein, in a molecular weight distribution determined by gel permeation chromatography (GPC) of a tetrahydrofuran (THF)-soluble matter of the resin fine particles, a peak top of a main peak is present within a range of molecular weights from 3,500 or more to 15,000 or less, a weight average molecular weight is 5,000 or more to 50,000 or less, and a content of a component with a molecular weight of 500 or more but less than 2,000 is 0.1% or more to 20.0% or less of a total amount of all components.

7. A method of manufacturing an aqueous dispersion of resin fine particles according to claim 1, wherein the surfactant comprises at least one selected from the group consisting of nonionic surfactants and anionic surfactants.

8. A method of manufacturing an aqueous dispersion of resin fine particles according to claim 1, wherein the basic substance comprises amine.

9. An aqueous dispersion of resin fine particles, which is obtainable by the method of manufacturing an aqueous dispersion of resin fine particles according to claim 1.

10. A method of manufacturing toner, comprising:
a aggregation step of mixing at least an aqueous dispersion of resin fine particles and a colorant to aggregate the resin fine particles and the colorant in an aqueous medium to form aggregates; and
a fusion step of heating the aggregates to fuse together,
wherein the aqueous dispersion of resin fine particles comprises the aqueous dispersion of resin fine particles according to claim 9.

11. A toner, which is obtainable by the method of manufacturing toner according to claim 10.
